(19) United States
(12) Patent Application Publication
(10) Pub. No.: US 2020/0164906 A1
(43) Pub. Date: May 28, 2020

(54) METHOD AND APPARATUS FOR TRANSMITTING DATA BETWEEN A FIRST COMMUNICATIONS NETWORK OF A FIRST TRACK-GUIDED VEHICLE UNIT AND A SECOND COMMUNICATIONS NETWORK OF A SECOND TRACK-GUIDED VEHICLE UNIT

(71) Applicant: SIEMENS MOBILITY GMBH, MUENCHEN (DE)

(72) Inventor: GEORG LOHNEIS, EBENSFELD (DE)

(21) Appl. No.: 16/627,517

(22) PCT Filed: Jun. 19, 2018
(86) PCT No.: PCT/EP2018/066168

§ 371 Date: Dec. 30, 2019

(30) Foreign Application Priority Data
Jun. 30, 2017 (DE) 10 2017 211 153.4

(51) Int. Cl. B61L 27/00; B61L 15/00; H04W 4/42; H04W 12/00

(52) U.S. Cl. CPC B61L 27/0005; B61L 27/0027; B61L 27/0094; B61L 15/0027; H04W 84/005; H04W 4/42; H04W 12/001; B61L 2205/00; B61L 27/0077

(57) ABSTRACT

A method and an apparatus transmit data between a first communications network of a first track-guided vehicle unit and a second communications network of a second track-guided vehicle unit. In order to ensure flexible data transmission between the first and second communications networks, the data between the first and second vehicle units are transmitted via a terrestrial data device.

The invention relates to a method and also an apparatus for transmitting data between a first communications network of a first rail-bound vehicle unit and a second communications network of a second rail-bound vehicle unit.

Modern rail-bound vehicles comprise a plurality of different systems for controlling the vehicle, the drive, the brakes, the doors, the lighting, the passenger information etc. The individual devices or components of a system of this type in this case communicate respectively with one another but also with devices or components of other systems in order to render possible an optimal cooperation of all the systems under different operating conditions and configurations of the vehicle and also to render possible a comprehensive diagnosis for a high availability of the vehicle.

Fundamentally it is known that rail-bound vehicles comprise a communications network for the purpose of communication. In this case, the communications network frequently comprises a train bus for communication between multiple vehicle units of the rail-bound vehicle. In this case, data is transmitted between the vehicle units via a wire-connected line as part of the train bus at the transition between the vehicle units. In other words: the train bus extends beyond a vehicle unit.

Against this background, the object of the invention is to improve the transmission of data between the first communications network and the second communications network.

This object is achieved by a method of the type mentioned in the introduction in which the data is transmitted between the first and second vehicle unit via a land-based data facility.

The invention is based on the knowledge that a wire-connected transmission of data between two vehicle units is associated with a large constructional outlay. Since, in addition to the mechanical coupling arrangement of the vehicle units, by way of example in order for the vehicle units to be brought together into one common rail-bound vehicle, the wire-connected transmission of data must be ensured by means of a cabling arrangement at the transition between the vehicle units. The solution in accordance with the invention solves this problem in that the data is transmitted via a land-based data facility.

One advantage is provided in particular in the case of rail-bound vehicle units that respectively comprise a data-technology connection to a land-based data facility: in the case of this configuration, the connections that are already provided may be used in order to transmit data between the first and second communications network.

The first and/or second vehicle unit is preferably embodied as a rail-borne vehicle unit. The term “vehicle unit” is preferably to be understood as a unit that cannot be separated or that cannot be divided any further, said vehicle unit comprising one or multiple carriages (frequently referred to as “consist”).

It is possible for different network components to be connected to the first or second communications network in a manner using data technology. It is preferred that the first or second communications network comprises a control network or is embodied from said control network. The person skilled in the art understands the term “control network” as a network that comprises one or multiple components for controlling the vehicle. By way of example, the control network comprises a drive controller, a brake controller and/or a component for managing communication between the rail-borne vehicle and the land-based data facility etc. The corresponding components are connected to one another via the control network in a manner using control technology and communications technology.

The land-based data facility preferably comprises a storage unit for storing, in particular buffering, the data that is to be transmitted. The land-based data facility further preferably comprises a server unit that is embodied so as to manage and/or to process the data that is to be transmitted. The server unit preferably further fulfils a safety-relevant function. The server unit preferably comprises an interference identifying unit that is embodied as an “intrusion detection system” and is used so as to identify attacks, attempts at misuse and/or security breaches that relate to the control network. The monitoring procedure preferably comprises a logging of incidents, creating and sending workshop messages and/or creating and sending operational messages. The monitoring procedure further preferably comprises a procedure of filtering or discarding data if the data does not fulfil predetermined characteristics and/or specifications.

In the case of one preferred embodiment of the method in accordance with the invention, the data is transmitted between the first and second communications network via a superordinate communications network.

The person skilled in the art preferably understands the wording “superordinate” to mean that the first and second communications network represent subordinate part networks within which it is possible to exchange data. The superordinate communications network is used to transmit data between the first and second communications network.

In the case of a further preferred embodiment of the method in accordance with the invention, the first communications network extends over the first vehicle unit, the second communications network extends over the second vehicle unit and/or the superordinate communications network extends over a rail-bound vehicle which comprises the first and second vehicle unit.

In other words: the first communications network is limited in its extent to the first vehicle unit and the second communications network is limited in its extent to the second vehicle unit.

It is preferred that the superordinate communications network comprises a bus structure, further preferably a so-called train bus.

In the case of a preferred development of the method in accordance with the invention, the data is transmitted between the first and second vehicle unit by means of the superordinate communications network via the land-based data facility. In other words: in accordance with this development the transmission to the superordinate communications network comprises the transmission via the land-based data facility (between the first and second vehicle unit).

It is preferred that the superordinate communications network uses a data-technology interface that is already provided so as to transmit data between the first or second vehicle unit and the land-based data facility. The interface comprises a transmitter-receiver unit of the first and second vehicle unit, said transmitter-receiver unit being embodied respectively so as to transmit data to the land-based data facility and so as to receive data from the land-based data facility. In one preferred variant, the transmitter-receiver unit forms a part of the superordinate communications network.

The land-based data facility may comprise further functions in addition to receiving data from the first communications network and relaying the data to the second communications network. By way of example, the land-based data facility provides passenger information for transmission to the first and/or second vehicle unit. It is preferred that the function of the data facility, according to which this data is received from the first communications network and the data is then relayed to the second communications network, is considered to be a part function of the superordinate communications network. In other words: the land-based data facility forms a part of the superordinate communications network.

It is preferred that the first communications network, the second communications network and/or the superordinate communications network comprise an Ethernet network or is embodied as such. Further preferably, a communication occurs between network components that are connected to the communications network using the TCP/IP (TCP: Transmission Control Protocol; IP: Internet Protocol).

According to a further preferred embodiment of the method in accordance with the invention, the data is transmitted in a wireless manner between the first or second vehicle unit and the land-based data facility. In other words: on the one hand the data is transmitted in a wireless manner between the first vehicle unit and the land-based data facility. On the other hand, the data is transmitted in a wireless manner between the land-based data facility and the second vehicle unit.

In the case of a development of this embodiment, the data is transmitted in a wireless manner using a mobile radio standard. By way of example, the data is transmitted using LTE (long term evolution).

In accordance with a further preferred embodiment of the method in accordance with the invention, the data is transmitted between the first or second vehicle unit and the land-based data facility in an encrypted manner. It is preferred that the encryption takes place using certificates for authentication of a provided relationship between a key for the encryption of the data and the sender of the data.

Further preferably, the wireless transmission of the data takes place in an encrypted manner.

In accordance with the method in accordance with the invention, the transmission of data via the land-based data facility is preferably triggered by a sender of the data. By way of example, a sender network component of the first communications network transmits the data. This data is then transmitted on its path via the land-based data facility to a destination network component of the second communications network.

In the case of another preferred embodiment of the method in accordance with the invention, a request in relation to data is sent originating from the second communications network to the land-based data facility, the request is sent originating from the land-based data facility to the first communications network and the requested data is provided by the first communications network in response to the request.

It is preferred that the request is transmitted from a network component that is connected in a manner using data technology to the second communications network. It is further preferred that the data is provided by a network component that is connected in a manner using data technology to the first communications network. It is further preferred that the requested data is provided in that this data is transmitted originating from the first communications network to the land-based data facility for further transmission to the second communications network.

In the case of a preferred embodiment of the method in accordance with the invention, the first vehicle unit and the second vehicle unit are part of a fleet of rail-bound vehicles. In this case, the vehicle units may be operated separately from one another (in other words not mechanically coupled), by way of example at locations remote from one another. This embodiment renders possible a flexible communication between vehicle units of a fleet of vehicles.

In the case of an alternative preferred embodiment of the method in accordance with the invention, the first vehicle unit and the second vehicle unit are part of a common rail-bound vehicle. In this case, the vehicle units are preferably mechanically coupled to one another. The rail-bound vehicle is preferably embodied as a rail-borne vehicle, further preferably as a multiple unit train. The embodiment renders possible particularly flexible communication between vehicle units of a rail-bound vehicle.

In the case of a further preferred embodiment of the method in accordance with the invention, data that is provided for a transmission between a first control network as the first communications network and a second control network as the second communications network is transmitted in a prioritized manner between
the first vehicle unit and the land-based data facility or
the second vehicle unit and the land-based data facility.

This has the advantage that a real-time communication between the control networks, which is regularly required for control networks, may be achieved.

The data that is provided for a transmission between the first control network and the second control network is preferably control data, by way of example sensor data such as speed signals, acceleration signals etc. The control data is preferably prioritized with respect to further data that is transmitted between the first or second vehicle unit and the land-based data facility. Further data is by way of example passenger information data, passenger entertainment data such as video data of an entertainment program for passengers.

The invention further relates to an apparatus for transmitting data between a first communications network of a first rail-bound vehicle unit and a second communications network of a second rail-bound vehicle unit. The apparatus is embodied so as to transmit the data between the first and second vehicle unit via a land-based data facility.

One preferred embodiment of the apparatus comprises a superordinate communications network that is embodied so as to transmit data between the first and second communications network.

In the case of a preferred development, the first communications network extends over the first vehicle unit, the second communications network extends over the second vehicle unit and/or the superordinate communications network extends over a rail-bound vehicle that comprises the first and second vehicle unit.

The invention further relates to a rail-bound vehicle comprising:
a first rail-bound vehicle unit having a first communications network,
a second rail-bound vehicle unit having a second communications network and
a superordinate communications network that is embodied so as to transmit data via a land-based data facility, said data being provided for a transmission between the first and second communications network.

The invention further relates to a communications network for transmitting data between a first communications network of a first rail-bound vehicle unit and a second communications network of a second rail-bound vehicle unit. The communications network comprises:
a land-based data facility,
a first data-technology connection between the first vehicle unit and the land-based data facility and
a second data-technology connection between the second vehicle unit and the land-based data facility,
   wherein the communications network is embodied as a superordinate communications network for transmitting data between the first communications network and the second communications network on a path via the first data-technology connection, the land-based data facility and the second data-technology connection.

The invention further relates to a use of a data-technology connection that is embodied so as to transmit data between a first and/or second vehicle unit and a land-based data facility so as to transmit data between a first communications network of a first rail-bound vehicle unit and a second communications network of a second rail-bound vehicle unit.

The person skilled in the art understands the wording “between a first and/or second vehicle unit and a land-based data facility” preferably to mean that a connection is embodied between the first vehicle unit and the land-based vehicle unit and also a connection is embodied between the second vehicle unit and the land-based data facility.

Exemplary embodiments of the invention are now explained with the aid of the figures. In the figures:

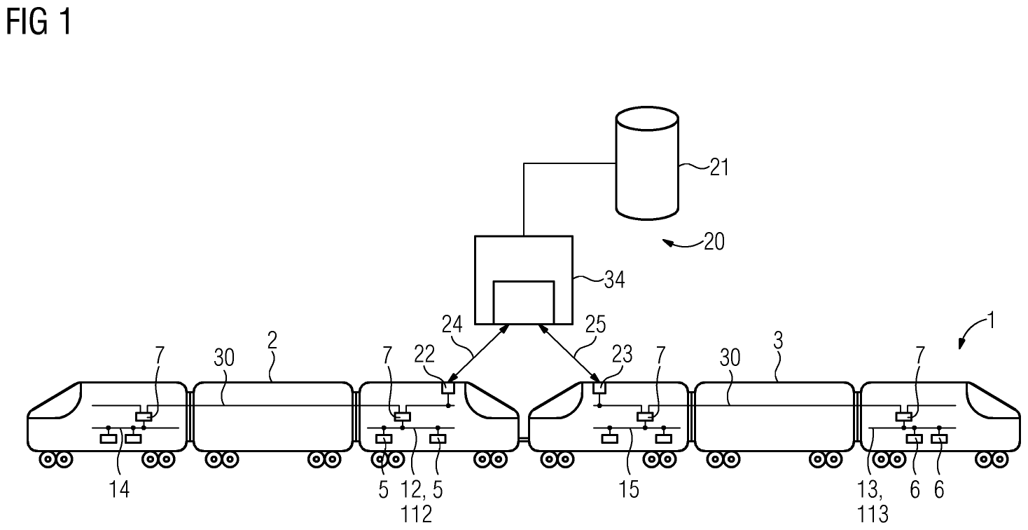

FIG. 1 shows a first exemplary embodiment of an apparatus in accordance with the invention in the case of a rail-bound vehicle,

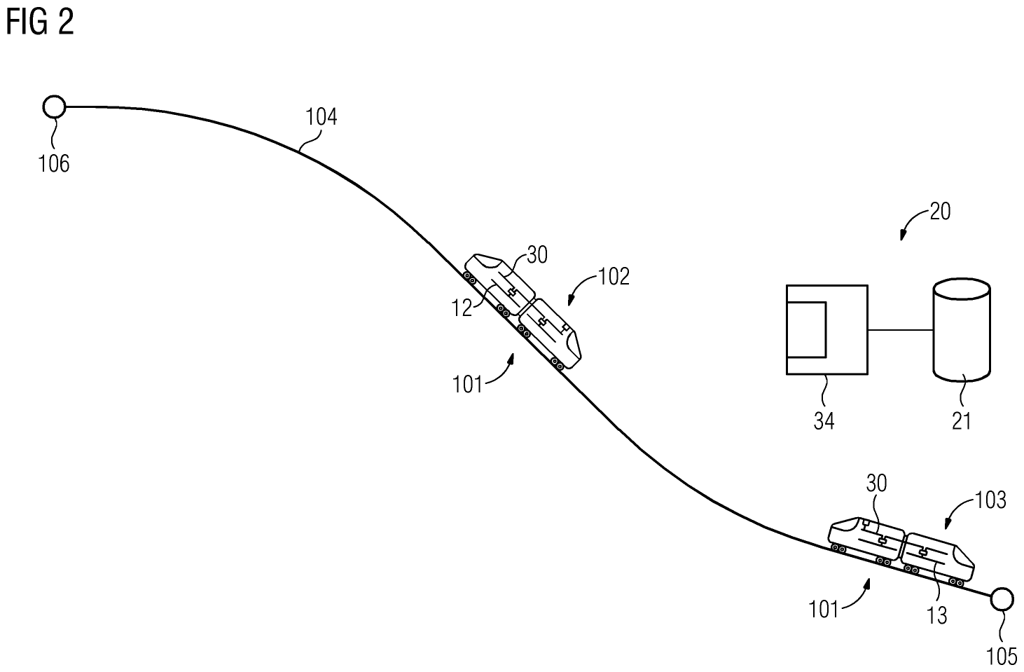

FIG. 2 shows a second exemplary embodiment of an apparatus in accordance with the invention as part of a rail-bound fleet of vehicles,

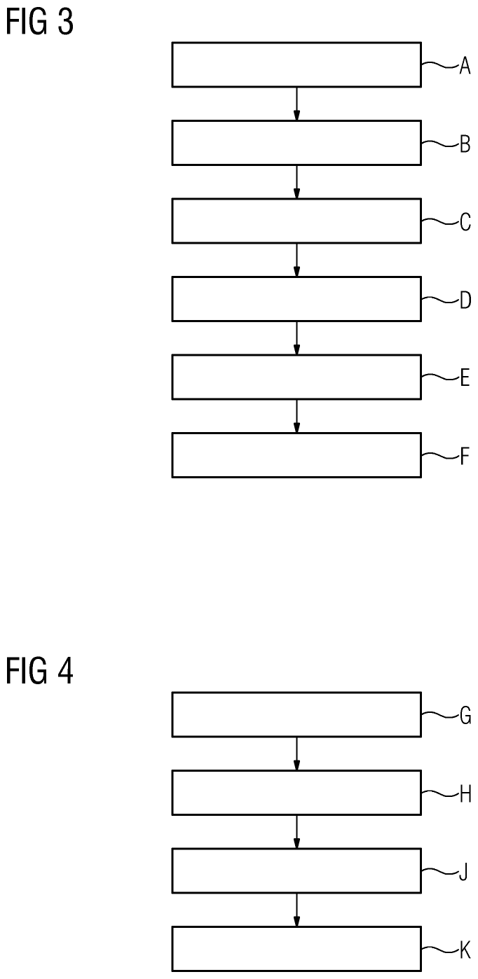

FIG. 3 shows a schematic flow diagram of a first exemplary embodiment of a method in accordance with the invention and

FIG. 4 shows a schematic flow diagram of a second exemplary embodiment of a method in accordance with the invention.

FIG. 1 illustrates a rail-bound vehicle 1 in a schematic side cross sectional view. In the embodiment taken into consideration, the rail-bound vehicle 1 is embodied as a rail-borne vehicle that comprises multiple carriages that are mechanically coupled. The rail-bound vehicle 1 comprises a first vehicle unit 2 and a second vehicle unit 3 that are coupled to one another. In other words: the first vehicle unit 2 and the second vehicle unit 3 are part of the rail-bound vehicle 1.

The first vehicle unit 2 comprises a first communications network 12 and the second vehicle unit 3 comprises a second communications network 13. The communications network 12 or 13 respectively forms a part network of the vehicle unit 2 or 3, wherein further part networks are provided, by way of example the part network 14 of the vehicle unit 2 and the part network 15 of the vehicle unit 3. The communications networks 12 and 13 each use the IP network protocol during operation and are embodied as Ethernet networks. Multiple network components 5 are connected in a manner using data technology to the first communications network 12 and multiple network components 6 are connected in a manner using data technology to the second communications network 13.

In order to render possible communication between the first communications network 12 and the second communications network 13, it is desirable to transmit data between these communications networks. For this purpose, data is transmitted between the first communications network 12 and the second communications network 13 via a land-based data facility 20 that comprises a server unit 21.

The vehicle unit 2 or 3 comprises a transmitter-receiver unit 22 or 23 for wireless transmission and receiving of data. The land-based data facility 20 comprises a transmitter-receiver unit 34 for the transmission and receiving of data. The transmitter-receiver units 22 and 34 form a part of a data-technology connection 24 between the first vehicle unit 2 and the land-based data facility 20. The transmitter-receiver units 23 and 34 form a part of a data-technology connection 25 between the first vehicle unit 2 and the land-based data facility 20.

The transmission of the data from the first communications network 12 to the second communications network 13 may be triggered by means of transmitting the data in a first method step A by way of the first communications network 12, in particular by way of one of the network components 5. The data is transmitted by means of the transmitter-receiver unit 22 to the land-based data facility 20 (method step B). In one method step C, the data is received by a transmitter-receiver unit 34 of the land-based data facility 20. The data is buffered by means of the server unit 21 (method step D) and is transmitted by means of the transmitter-receiver unit 34 to the transmitter-receiver unit 23 of the second vehicle unit 3 (method step E). The transmitter-receiver unit 23 receives the data in a method step F. The data is then relayed to the desired destination, by way of example one of the network components 6.

The data is transmitted in a wireless manner between the transmitter-receiver unit 22 or 23 and the transmitter-receiver unit 34 using a mobile radio standard, by way of example LTE (long term evolution). Moreover, the data is transmitted in an encrypted manner between the first and second communications network 12 and 13, in particular between the transmitter-receiver unit 22 or 23 and the transmitter-receiver unit 34.

The transmission of the data between the first and second communications network may alternatively also be triggered by means of the second communications network 13. For this purpose, a request that relates to receiving data is transmitted via the transmitter-receiver unit 23 (method step G). The transmitter-receiver unit 34 receives the data. The data facility 20 transmits the request via the transmitter-receiver unit 34 and the transmitter-receiver unit 22 to the first communications network 12 (method step H). The first communications network 12 provides the requested data in a method step J in response to receiving the request in that the data is transmitted (via the transmitter-receiver units 22 and 34) to the data facility 20 (method step K) and from there is transmitted to the second communications network 13.

The communications networks 12 and 13 form subordinate part networks that extend in particular over the respective vehicle unit 2 and 3, in particular over a respective part region of the vehicle units 2 and 3. The vehicle units 2 and 3 form train units that cannot be further divided (frequently also described as “consist”). The subordinate part networks comprise a bus structure that is frequently referred to as a vehicle bus.

The subordinate part networks 12, 13, 14 and 15 are respectively coupled via an address translation facility in the form of a NAT router 7 (NAT: Network Address Translation) to a superordinate communications network 30. The superordinate communications network 30 extends respectively at least over the vehicle unit 2 or 3 and beyond. In particular, the superordinate communications network 30 extends over the rail-bound vehicle 1 having its vehicle units 2 and 3. The superordinate communications network 30 comprises a bus structure that is frequently referred to by people skilled in the art as train bus.

The superordinate communications network 30 has by way of example the object of transmitting data between the first communications network 12 and the second communications network 13. The superordinate communications network 30 utilizes for this purpose a transmission path via the land-based data facility 20.

In other words: data is transmitted between the first communications network 12 and the second communications network 13 via the superordinate communications network 30. In the case of hitherto known solutions (prior art), the data is transmitted in a wire-connected manner between the vehicle units 2 and 3, in particular by means of a wire-connected connection at the transition between the vehicle units. In contrast thereto, the solution in accordance with the invention provides that the data is transmitted between the vehicle units 2 and 3 in a wireless manner via a land-based data facility 20.

The communications network 12 or 13 is embodied as a control network 112 or 113. The data that is provided for a transmission between the first and second communications network 12 and 13 comprises control data, by way of example sensor data such as speed signals and acceleration signals. The control data is transmitted via the connection 24 and 25 in a prioritized manner with respect to other data. Other data comprises by way of example passenger information data and data for a passenger entertainment system.

FIG. 2 illustrates the apparatus in accordance with the invention that is described in relation to FIG. 1 as a part of a fleet of rail-bound vehicles 101. Identical and functionally identical components are provided in this case with the same reference numerals as in FIG. 1.

The fleet of vehicles 101 that is illustrated in FIG. 2 comprises a first vehicle unit 102 and a second vehicle unit 103. The vehicle units 102 and 103 move on a route 104 between a starting point 105 and a destination point 106. The vehicle unit 102 or 103 comprises a first communications network 12 or a second communications network 13. For a transmission of data between the first and second communications network 12 and 13 this data is transmitted between the first vehicle unit 102 and the second vehicle unit 103 via the land-based data facility 20.

1-15. (canceled)

16. A method for transmitting data between a first communications network of a first rail-bound vehicle unit and a second communications network of a second rail-bound vehicle unit, which comprises the steps of:
transmitting the data between the first rail-bound vehicle unit and the second rail-bound vehicle unit via a land-based data facility.

17. The method according to claim 16, which further comprises transmitting the data between the first communications network and the second communications network via a superordinate communications network.

18. The method according to claim 17, wherein:
the first communications network extends over the first rail-bound vehicle unit;
the second communications network extends over the second rail-bound vehicle unit; and/or
the superordinate communications network extends over a rail-bound vehicle that contains the first rail-bound vehicle unit and the second rail-bound vehicle unit.

19. The method according to claim 18, which further comprises transmitting the data between the first rail-bound vehicle unit and the second rail-bound vehicle unit via the land-based data facility by means of the superordinate communications network.

20. The method according to claim 16, which further comprises transmitting the data in a wireless manner between:
the first rail-bound vehicle unit or the second rail-bound vehicle unit; and
the land-based data facility.

21. The method according to claim 20, wherein the data transmitted in the wireless manner is transmitted using a mobile radio standard.

22. The method according to claim 16, which further comprises transmitting the data in an encrypted manner between:
the first rail-bound vehicle unit or the second rail-bound vehicle unit; and
the land-based data facility.

23. The method according to claim 16, which further comprises:
sending a request for data, originating from the second communications network, to the land-based data facility;
forwarding the request from the land-based data facility to the first communications network; and
providing requested data by the first communications network in response to the request.

24. The method according to claim 16, wherein:
the first rail-bound vehicle unit and the second rail-bound vehicle unit are part of a fleet of rail-bound vehicles; and/or
the first rail-bound vehicle unit and the second rail-bound vehicle unit are part of a common rail-bound vehicle.

25. The method according to claim 16, wherein the data that is provided for a transmission between a first control network as the first communications network and a second control network as the second communications network are transmitted in a prioritized manner between:
the first rail-bound vehicle unit and the land-based data facility; or
the second rail-bound vehicle unit and the land-based data facility.

26. An apparatus for transmitting data, the apparatus comprising:
a first communications network for a first rail-bound vehicle unit;
a second communications network for a second rail-bound vehicle unit; and
a land-based data facility, the apparatus embodied so as to transmit the data between the first rail-bound vehicle unit and the second rail-bound vehicle unit via said land-based data facility.

27. The apparatus according to claim 26, further comprising a superordinate communications network embodied so as to transmit the data between said first communications network and said second communications network.

28. The apparatus according to claim 27, wherein:
said first communications network extends over the first rail-bound vehicle unit;
said second communications network extends over the second rail-bound vehicle unit; and/or
said superordinate communications network extends over a rail-bound vehicle that includes the first rail-bound vehicle unit and the second rail-bound vehicle unit.

29. A communications network for transmitting data between a first communications network of a first rail-bound vehicle unit and a second communications network of a second rail-bound vehicle unit, the communications network comprising:
a land-based data facility;
a first data-technology connection between the first rail-bound vehicle unit and said land-based data facility;
a second data-technology connection between the second rail-bound vehicle unit and said land-based data facility; and
a superordinate communications network for transmitting data between the first communications network and the second communications network on a path via said first data-technology connection, said land-based data facility and said second data-technology connection.

30. A method of using a data-technology connection embodied so as to transmit data between a first rail-bound vehicle unit and/or a second rail-bound vehicle unit and a land-based data facility, which comprises the steps of:
transmitting the data between a first communications network of the first rail-bound vehicle unit and a second communications network of the second rail-bound vehicle unit.
